(19) United States
(12) Patent Application Publication
(10) Pub. No.: US 2025/0132553 A1
(43) Pub. Date: Apr. 24, 2025

(54) ELECTRICAL ASSEMBLY

(71) Applicant: Lear Corporation, Southfield, MI (US)

(72) Inventors: Antoni Ferré Fàbregas, Valls (ES); Carlos Fernandez Pueyo, Valls (ES); Antoni Duran Holgado, Valls (ES); Marc Miro Bargallo, Valls (ES)

(73) Assignee: Lear Corporation, Southfield, MI (US)

(21) Appl. No.: 18/914,538

(22) Filed: Oct. 14, 2024

Related U.S. Application Data
(60) Provisional application No. 63/591,490, filed on Oct. 19, 2023.

(51) Int. Cl. H02H 3/093; H02H 3/07; H02H 3/44

(52) U.S. Cl. CPC H02H 3/0935; H02H 3/07; H02H 3/44

(57) ABSTRACT

An electrical assembly includes a conductor; a switch electrically connected to the conductor; and a control circuit connected to the switch, the control circuit including at least one of an electronic controller, a sensor, or a filter. The control circuit can be configured to operate the switch according to a maximum energy capacity of the conductor and a net energy of the conductor.

### CROSS-REFERENCE TO RELATED APPLICATIONS

This application claims the benefit of and priority to U.S. Provisional Application 63/591,490 filed Oct. 19, 2024, the disclosure of which is hereby incorporated by reference in its entirety as though fully set forth herein.

### TECHNICAL FIELD

The present disclosure generally relates to electrical assemblies, including electrical assemblies that may be utilized in connection with monitoring and/or protecting conductors

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of an electrical assembly according to teachings of the present disclosure.

FIG. 2 is a flow diagram generally illustrating an embodiment of a method of operating an electrical assembly according to teachings of the present disclosure.

FIG. 3 is a flow diagram generally illustrating an embodiment of a method of determining net energy according to teachings of the present disclosure.

FIG. 4 is a flow diagram generally illustrating an embodiment of a method of determining net energy according to teachings of the present disclosure.

FIG. 5 is a flow diagram generally illustrating an embodiment of a method of determining net energy according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

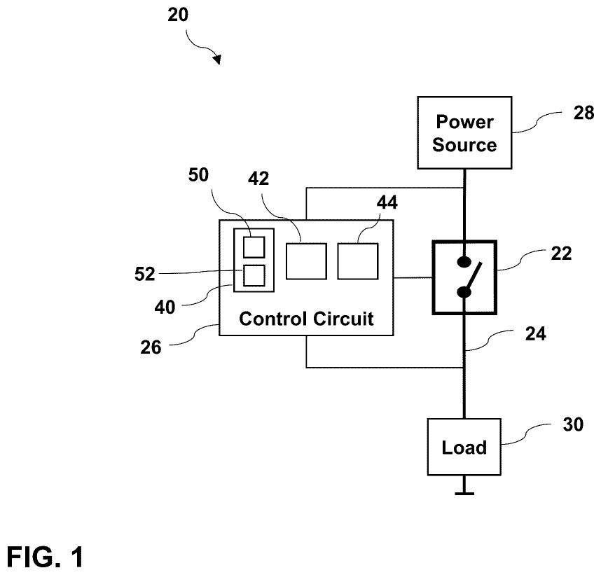

Referring to FIG. 1, Referring to FIG. 1, an electrical assembly 20 includes a switch 22, a conductor 24, a control circuit 26, a power source 28, and a load 30. The switch 22 is connected between the power source 28 and the load 30 such that the switch 22 selectively provides power from the power source 28 to the load 30. The conductor 24 connects the switch 22 with the load 30. The control circuit 26 controls operation of the switch 22. For example, the control circuit 26 can control the switch 22 to selectively provide power to the load 30, and/or can control the switch 22 according to one or more characteristics of the conductor 24. The one or more characteristics can include one or more of electrical current, voltage, or energy, among others. The control circuit 26 can control the switch 22 according to the one or more characteristics to prevent damage to and/or malfunctioning of the conductor 24. The conductor 24 can include one or more of a variety of configurations, such as a cable, a wire, or a bus bar, among others, or combinations thereof. The conductor 24 can be a standalone component connecting other components and can be incorporated into other components, such as fuses, motors, pumps, or circuit boards, among others.

The control circuit 26 includes an electronic controller 40, a sensor 42, and/or a filter 44. The electronic controller 40 can include a processor 50 and a memory 52. The sensor 42 can include one or more sensors, such as an electrical current sensor. The filter 44 can include one or more filters, such as moving average and/or decimation filter. The control circuit 26 can be connected to the switch 22, across the switch 22, and/or to the conductor 24. While illustrated with the electronic controller 40, the sensor 42, and the filter 44, the control circuit 26 can include one or a combination of the electronic controller 40, the sensor 42, and the filter 44, and can include other components.

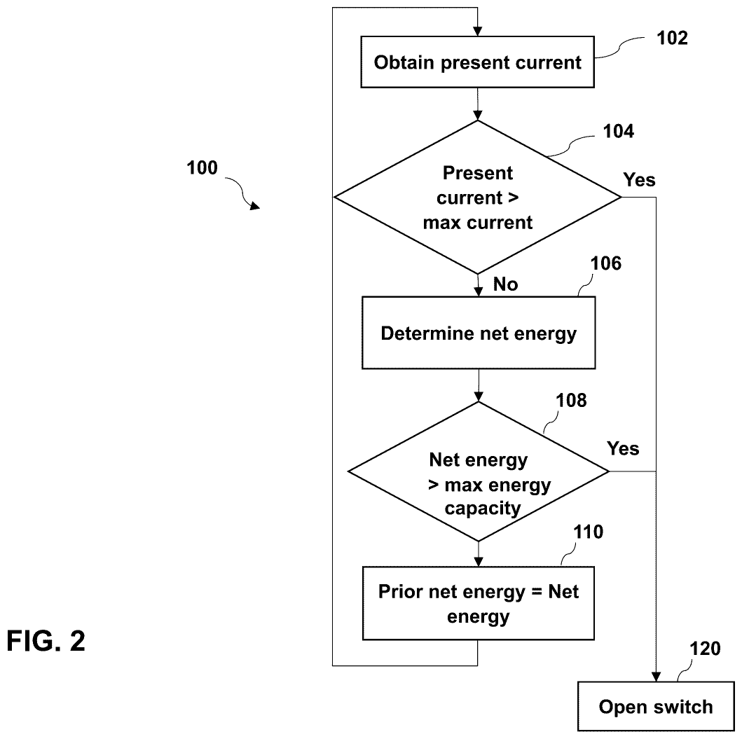

Referring to FIG. 2, a method 100 of operating an electrical assembly 20 is illustrated. The method 100 can be conducted, at least in part via the control circuit 26. The method 100 includes obtaining (e.g., sensing via the sensor 42) a present electrical current of the electrical assembly 20 (block 102), such as at the switch 22 and/or at the conductor 24. The control circuit 26 compares the present current to a maximum current threshold (block 104). The maximum current threshold can be predetermined, such as according to a current rating of the conductor 24 and/or the load 30. If the present current is greater than the maximum current threshold, the control circuit 26 may determine a fault has occurred and/or open the switch 22 (block 120) to disconnect the power source 28 from the conductor 24 and the load 30. If the present current is equal to or less than the maximum current threshold, the control circuit 26 determines a net energy of the electrical assembly 20 (block 106), such as of the conductor 24. The net energy may be represented as the difference between sensed energy and energy dissipation:

$$Net Energy = Sensed Energy - Dissipation \qquad Eq . 1$$

The sensed energy can include some or all prior sensed energy and the dissipation can include some or all prior dissipation. The control circuit 26 may determine the net energy according to the sum of the previous net energy value, which can include some or all prior sensed energy and/or prior dissipation, and the sensed energy for the present sample time, less the dissipation for the present sample time. The sensed energy can represent the amount of energy transferred by the conductor 24.

$$Net energy [ n ] = Net energy [ n - 1 ] + sensed energy [ n ] - dissipation [ n ] \qquad Eq . 2$$

In block 108, the control circuit 26 compares the net energy to a maximum energy capacity of the electrical assembly 20, such as of the conductor 24. If the net energy exceeds the maximum energy capacity, the control circuit 26 may determine a fault has occurred and/or open the switch 22 (block 120). Opening the switch 22 can protect the conductor 24 and/or the load 30 from damage, and method 100 may be referred to as a method of protecting a conductor and/or a load. Optionally, the control circuit 26, after opening the switch 22, can close the switch 22 if one or more conditions are met. For example, the control circuit 26 may close the switch 22 after a certain time period and/or after sufficient energy has dissipated from the conductor 24. The number of times the control circuit 26 closes the switch 22 after having previously opened the switch 22 due to a fault can be configurable.

If the net energy is equal to or less than the maximum energy capacity, the control circuit 26 may not detect a fault, the control circuit 26 may set the prior net energy as equal to the net energy (block 110), and/or the method 100 may return to block 102. The maximum energy capacity can be a predetermined value and may correspond to one or more characteristics of the conductor 24.

While the method 100 and the Equations are generally described as adding present energy to prior energy, subtracting dissipation, and comparing the result to the maximum energy capacity, the method 100 and the Equations can also be utilized with a starting energy capacity or budget equal to the maximum energy capacity, subtracting present energy from the prior energy budget and adding dissipation to obtain a present energy budget, and detecting a fault and/or opening the switch 22 if the present energy budget is below zero. The control circuit 26 then sets the prior energy budget equal to the present energy budget and repeats the method. With such an energy budget configuration, the remaining energy budget may be available without further calculation, such as without determining the difference between the net energy and the maximum energy capacity. The control circuit 26 can determine an energy capacity value, which can include the net energy or the remaining energy capacity. If the energy capacity value is the net energy, the control circuit 26 can compare the energy capacity value to the maximum energy capacity and open the switch 22 if the energy capacity value exceeds the maximum energy capacity. If the energy capacity value is the remaining energy capacity, the control circuit 26 can compare the energy capacity value to zero and open the switch 22 if the energy capacity value is negative or more than a threshold below zero.

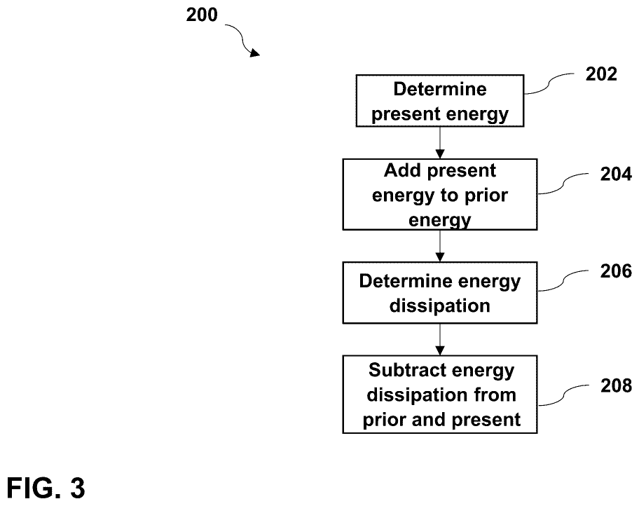

Referring to FIG. 3, a method 200 of determining the net energy (block 106 of method 100) is illustrated. The method 200 includes obtaining a sensed energy (block 202). Obtaining the sensed energy can include the control circuit 26 squaring the present current sensed by the sensor 42 and multiplying that product by a sample time. In some examples, the control circuit 26 may multiply the sensed energy by a first energy factor EF1. For example, the present energy may be represented as follows:

$$Present energy = {I}_{sense}^{2} * {T}_{sample} * EF 1 \qquad Eq . 3$$

The sample time can include an amount of time between obtaining consecutive values (e.g., samples) of the present current sensed via the sensor 42, such as in block 102 of method 100. The first energy factor EF1 can correspond to rate that capacity of conductor 24 is consumed as current flows. In some cases, to simplify the determination, the first energy factor EF1 can be set as 1.

The method 200 includes the control circuit 26 adding the sensed energy to a prior net energy (block 204). If the method 200 has not previously been conducted and/or the prior net energy has not been determined, the prior net energy may be set to zero, a steady-state value, or another value. In block 206, the control circuit 26 determines an energy dissipation. In block 208, the control circuit 26 subtracts the energy dissipation from the sum of the prior net energy and the sensed energy to obtain the net energy. The net energy can then be used in method 100, such as in block 108 and/or block 110. In determining the net energy, such as in subtracting the energy dissipation in block 208, the control circuit 26 may limit a minimum value of the net energy to zero such that the net energy cannot be negative, such as to maintain the applicability of the maximum energy capacity. If the net energy were permitted to be negative without adjusting the maximum energy capacity, energy exceeding the energy capacity may improperly be provided to the conductor 24.

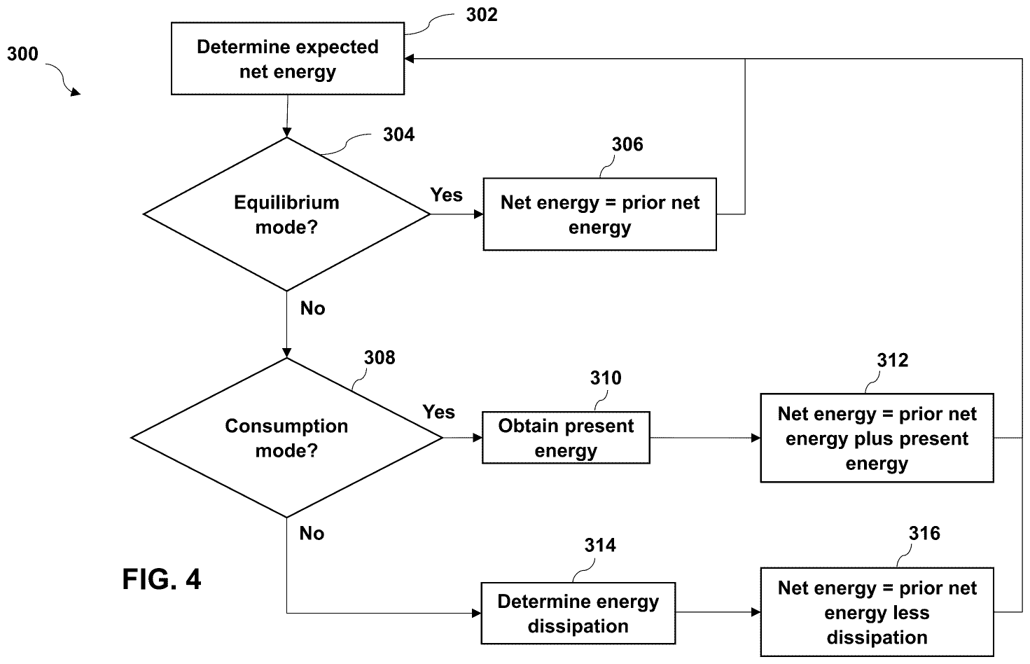

Referring to FIG. 4, a method 300 of determining the net energy (block 106 of method 100) is illustrated. The method 300 can be utilized instead of or in addition to method 200. For example, in some configurations, the control circuit 26 could utilize an average of the net energy values determined by method 200 and method 300.

In block 302, the control circuit 26 determines an expected net energy. Determining the expected net energy can include determining the difference between the squared nominal current and the squared sensed current, multiplying that difference by a steady state time, and then subtracting that product from the energy capacity:

$$Expected Net Energy = Energy capacity - ( {I}_{nominal}^{2} - {I}_{sense}^{2} ) * {T}_{lim} \qquad Eq . 4$$

For example, if the sensed current is equal to the nominal current, the expected net energy is equal to the energy capacity. If the sensed current is zero, the expected net energy is zero. The steady state time can include the amount of time involved for the maximum energy capacity of the conductor 24 to be reached (or for the energy budget to reach zero) with the nominal current flowing in the conductor 24. If the control circuit 26 is subtracting net energy from the energy capacity, the expected net energy may be determined via the second term (e.g., the difference between the squared nominal current and the squared sensed current, multiplying that difference by a steady state time).

In block 304, the control circuit 26 determines if the electrical assembly 20 and/or the conductor 24 is in an equilibrium mode. The control circuit 26 may determine that the electrical assembly 20 and/or the conductor 24 is in the equilibrium mode if (a) the expected net energy is within a tolerance threshold of a prior net energy and (b) the present current is less than or equal to a nominal current (and present current squared is less than or equal to nominal current squared). The tolerance threshold can be configured to compensate for small transients and may be small, such as equal to or between 0.01 and 0.03 in some examples. If the control circuit 26 determines that the electrical assembly 20 and/or the conductor 24 is in the equilibrium mode (e.g., conditions (a) and (b) are met), the control circuit 26 may determine that the net energy is equal to the prior net energy (block 306).

If the control circuit 26 determines that the electrical assembly 20 and/or the conductor 24 is not in the equilibrium mode (e.g., one or both of conditions (a) and (b) are not met), the control circuit 26 determines if the electrical assembly 20 and/or the conductor 24 is in a consumption mode (block 308). The control circuit 26 may determine that the electrical assembly 20 and/or the conductor 24 is in the consumption mode if (c) the expected net energy is greater than the prior net energy, or (d) the present current is greater than the nominal current. If either or both conditions are met, the method proceeds to block 310 and the control circuit 26 obtains a sensed energy, which may be conducted in the same manner as described above in connection with block 202 of method 200. The method 300 then proceeds to block 312 and the control circuit 26 determines that the net energy equals the prior net energy plus the sensed energy.

If neither of conditions (c) or (d) is met, the control circuit 26 determines that the electrical assembly 20 and/or the conductor 24 is not in the consumption mode and is in a dissipation mode. The method 300 then proceeds to block 314 in which the control circuit 26 determines an energy dissipation. The control circuit 26 may determine the energy dissipation, at least in part, according to the present current and the nominal current. The method then proceeds to block 316 in which the control circuit 26 determines the net energy by subtracting the energy dissipation from the prior net energy.

Optionally, in block 308, the control circuit 26 may instead determine if the electrical assembly 20 and/or the conductor 24 is in a dissipation mode, such as if (e) the expected net energy is less than the prior net energy, and (f) the present current is less than or equal to the nominal current. If both conditions are met, the method 300 may proceed to block 312. If either condition is not met, the method 300 may proceed to block 314.

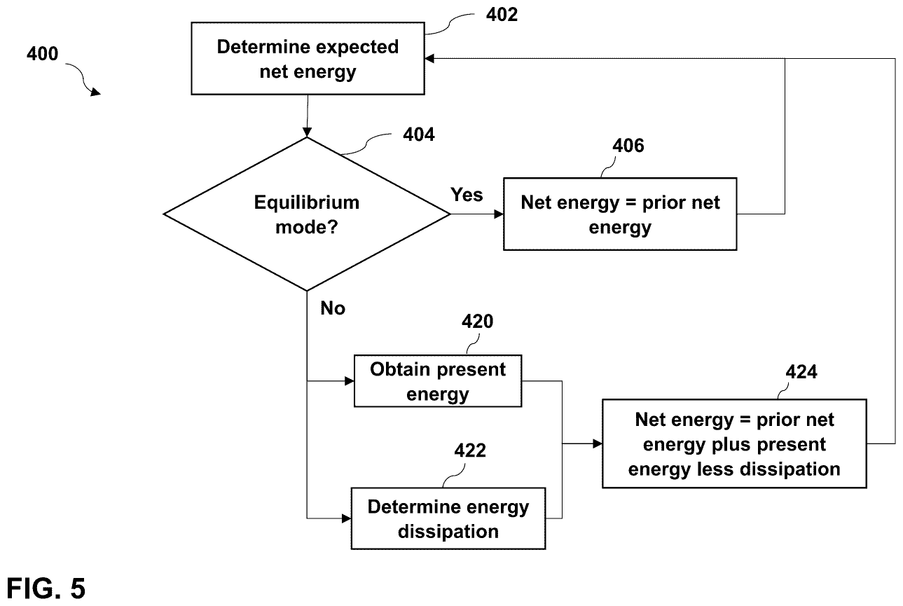

Referring to FIG. 5, a method 400 of determining the net energy (block 106 of method 100) is illustrated. The method 400 is similar to the method 300. For example, the method 400 includes determining an expected net energy (block 402) and determining if the electrical assembly 20 and/or the conductor 24 is in an equilibrium mode (block 404), which can be carried out in the same manner as blocks 302 and 304, respectively, of method 300. If the electrical assembly 20 and/or the conductor 24 is in the equilibrium mode, the control circuit 26 sets the net energy equal to the prior net energy (block 406). If the electrical assembly 20 and/or the conductor 24 is not in the equilibrium mode, the method 400 proceed to blocks 420 and 422 to obtain the sensed energy and determine energy dissipation, respectively, such as instead of determining if the electrical assembly 20 and/or the conductor 24 is in a consumption mode (block 308 of the method 300). Then, in block 424, the control circuit 26 determines that the net energy is the sum of prior net energy and the sensed energy less the energy dissipation.

In some examples, the control circuit 26 may determine, such as in blocks 206, 314, 422 of the methods 200, 300, 400, that the energy dissipation is equal to one minus the quotient of the present current squared divided by the nominal current squared, all multiplied by the quotient of the sample period divided by a recovery period:

$$Dissipation = {T}_{sample} / {T}_{recovery} * ( 1 - {I}_{sense}^{2} / {I}_{nom}^{2} ) \qquad Eq . 5$$

The recovery period can include an amount of time for the electrical assembly 20 and/or the conductor 24 to dissipate all energy at zero current.

In some other examples, the control circuit 26 may determine, such as in blocks 206, 314, 422 of the methods 200, 300, 400, that the energy dissipation is equal to one minus the quotient of the present current squared divided by the nominal current squared, all multiplied by the quotient of the sample period divided by the sum of a time constant and the sample time:

$$Dissipation = {T}_{sample} / ( τ + {T}_{sample} ) * ( 1 - {I}_{sense}^{2} / {I}_{nom}^{2} ) \qquad Eq . 6$$

Where t is the time constant of a first-order exponential system. For example, Equation 6 may be utilized to simulate exponential energy dissipation.

In some examples, the control circuit 26 may determine a squared current value for some or each present current value obtained and/or for each sample period. The control circuit 26 may store the squared current values in a one-dimensional array with a length of M cells, such as in the memory 52. The values may be stored in a first in first out (FIFO) manner. With some examples, the control circuit 26 may determine the energy dissipation, such as in blocks 206, 314, 422 of the methods 200, 300, 400, according to the oldest squared current value stored in the array that is being removed to add the present squared current value. For example, if the control circuit 26 is utilizing sample time in determining dissipation, the control circuit 26 may multiply the oldest squared current by the sample time to determine the dissipation, remove that oldest squared current value from the array, and add the present squared current value in the array. In some examples, the control circuit 26 may multiply the oldest squared current value by a second energy factor EF2 and the sample time, and utilize the product thereof as the energy dissipation. The second energy factor EF2 can correspond to the amount of energy dissipated for a particular conductor 24 (e.g., the materials of the conductor 24) and/or for the environmental conditions of the electrical assembly 20, for example. If the control circuit 26 is not utilizing sample time, the control circuit 26 may set the dissipation as equal to the oldest squared current value from the array and may or may not multiply by the second energy factor EF2.

With some examples, the control circuit 26 may determine the energy dissipation, at least in part, according to the prior net energy multiplied by a third energy factor EF3. For example the control circuit 26 may utilize the sum of (i) that product and (ii) the product of the oldest squared current value I_{n-M}², the second energy factor EF2, and the sample time Tₛₐₘₚₗₑ as the dissipation:

$$Dissipation = {I}_{n - M}^{2} * {T}_{sample} * EF 2 + {E}_{M} [ n - 1 ] * EF 3 \qquad Eq . 7$$

The third energy factor EF3 can correspond to natural cooling of the conductor 24. In some cases, to simplify the determination, the third energy factor EF3 can be set as 1 or 0.

In some examples, the control circuit 26 may, for a particular sample time n and an array of length M, determine the net energy E_{M}[n] at a sample time n according to Equation 2, which can be represented as:

$${E}_{M} [ n ] = {E}_{M} [ n - 1 ] + {I [ n ]}_{sense}^{2} * {T}_{sample} * EF 1 - {I}_{n - M}^{2} * {T}_{sample} * EF 2 - {E}_{M} [ n - 1 ] * EF 3 \qquad Eq . 8$$

With some examples, the control circuit 26 may normalize one or more of the net energy, the present energy, or the dissipation, which may simplify the determinations and/or the output (e.g., the net energy may be represented as a ratio or percentage of maximum capacity used or remaining). For example, the control circuit 26 may divide the net energy, present energy, and the dissipation by the energy capacity E_{Max} such that each of net energy, present energy, and the dissipation is a value equal to or between 0 and 1.

In some examples, the determination of net energy may be further simplified by setting the second energy factor EF2 to one and the third energy factor EF3 to zero. For example, normalizing and simplifying Equation 8 can result in the following:

$${e}_{M} [ n ] = {e}_{M} [ n - 1 ] + ( {I [ n ]}_{sense}^{2} * {T}_{sample} ) / {E}_{Max} - ( {I}_{n - M}^{2} * {T}_{sample} ) / {E}_{max} \qquad Eq . 9$$

With some examples, the control circuit 26 may determine energy values, such as the net energy, present energy, and dissipation independent of time, so the determined values are measured in Amps squared instead of Amps squared/second. For example, as each term may otherwise be determined as a function of the sample time, removing the sample time from the determinations can make the determinations more efficient (e.g., use less computing resources of the electronic controller 40, use less power, make determinations faster). A time-independent and simplified version of Equation 8 can result in the following:

$${ET}_{M} [ n ] = {ET}_{M} [ n - 1 ] + {I [ n ]}_{sense}^{2} - {I}_{n - M}^{2} \qquad Eq . 10$$

The control circuit 26 may compare ET_{M}[n] to the energy capacity, which can be determined by dividing the energy capacity by the sample time such that the energy capacity is measured in Amps squared, making the energy capacity also independent of time.

Embodiments of the electrical assembly 20 and methods of operating the electrical assembly 20, such as methods 100, 200, 300, may provide better monitoring and/or protection of a conductor, such as conductor 24, than other designs. For example, other designs may rely only on comparing a sensed electrical current to a maximum electrical current and may not consider the energy capacity of the conductor or the cumulative effects of present energy and energy dissipation, such as with variable and/or non-periodic currents. Embodiments of the current disclosure can be configured to consider the energy capacity of the conductor and the cumulative effects of present energy and energy dissipation, such as with variable and/or non-periodic currents. Additional or alternatively, embodiments of the present disclosure can utilize measured electrical current to estimate energy dissipation in a physical manner based on conductor parameters, while other designs may rely only on elapsed time. Additionally or alternatively, embodiments of the present disclosure may operate more efficiently than other designs, such as by utilizing few computing resources and/or consuming less power. For example, one or more embodiments of the present disclosure may not rely on calculating averages of electrical current values, and may instead utilize the present/sensed current and a prior energy value that already incorporates prior electrical current values. Additionally or alternatively, other designs may rely on temperature and/or voltage sensors or values, and embodiments of the present disclosure may operate independently of temperature and/or voltage sensors or values.

The instant disclosure includes the following non-limiting embodiments:

An electrical assembly, comprising: a conductor; a switch electrically connected to the conductor; and a control circuit connected to the switch, the control circuit including at least one of an electronic controller, a sensor, or a filter; wherein the control circuit is configured to operate the switch according to a maximum-energy capacity of the conductor and a net energy of the conductor.

The electrical assembly of any preceding embodiment, wherein operating the switch includes opening the switch in accordance with determining that the net energy exceeds the maximum energy capacity.

The electrical assembly of any preceding embodiment, wherein the control circuit is configured to determine an energy dissipation of the conductor and determine the net energy, at least in part, according to the energy dissipation.

The electrical assembly of any preceding embodiment, wherein the control circuit determines the energy dissipation, at least in part, according to a difference between a sensed energy and a nominal energy of the conductor.

The electrical assembly of any preceding embodiment, wherein the net energy of the conductor includes a sum of a present energy value and a prior energy value.

The electrical assembly of any preceding embodiment wherein the control circuit includes the sensor; the prior energy value includes a prior present energy value and a second prior energy value; and the control circuit obtains the present energy value via the sensor.

The electrical assembly of any preceding embodiment, wherein the sensor is connected to sense a current at the switch; and the present energy value corresponds to the current at the switch.

An electrical assembly, comprising: a conductor; a switch electrically connected to the conductor; and a control circuit connected to the switch, the control circuit including at least one of a controller, a sensor, or a filter; wherein the control circuit: determines whether the conductor is in an equilibrium mode, a consumption mode, or a recovery mode; determines an energy capacity value of the conductor according to the determined mode; and controls the switch according to the energy capacity value.

The electrical assembly of any preceding embodiment, wherein controlling the switch according to the determined energy capacity value includes opening the switch if the energy capacity value exceeds a maximum energy capacity of the conductor.

The electrical assembly of any preceding embodiment, wherein the control circuit determines that the conductor is in the equilibrium mode in accordance with determining that (i) a present current is less than or equal to a maximum current, and (ii) an expected capacity is within a threshold amount of a prior energy capacity value.

The electrical assembly of any preceding embodiment, wherein the expected capacity corresponds to a difference between a steady state current of the conductor squared and a measured current squared, multiplied by a steady state time.

The electrical assembly of any preceding embodiment, wherein the control circuit determines that the conductor is in the consumption mode in accordance with determining that the present current is greater than a nominal current of the conductor, and the control circuit also determines that the conductor is in the consumption mode in accordance with determining that the expected capacity is less than the prior energy capacity value by more than the threshold amount.

The electrical assembly of any preceding embodiment, wherein the control circuit determines that the conductor is in the recovery mode in accordance with determining that (i) the conductor is not in the equilibrium mode or the consumption mode, and/or (ii) both of (a) the present current is less than or equal to the nominal current of the conductor, and (b) the expected capacity is greater than the prior energy capacity value by more than the threshold amount.

The electrical assembly of any preceding embodiment, wherein: in accordance with determining that the conductor is in the equilibrium mode, the control circuit determines the energy capacity value is equal to the prior energy capacity value; in accordance with determining that the conductor is in the consumption mode, the control circuit determines the energy capacity value is equal to a difference between the prior energy capacity value and a present energy of the conductor; in accordance with determining that the conductor is in the recovery mode, the control circuit determines the energy capacity value equals a sum of the prior energy capacity value and an energy dissipation; and operating the switch according to the energy capacity value includes opening the switch if the energy capacity value is negative.

The electrical assembly of any preceding embodiment, wherein the control circuit determines the energy capacity value for a plurality of sample periods.

A method of operating an electrical assembly, the method comprising: determining a present energy of a conductor; determining an energy dissipation of the conductor; determining a net energy of the conductor, at least in part, according to the present energy and the energy dissipation; opening a switch electrically connected with the conductor in accordance with determining that the net energy exceeds a maximum energy capacity of the conductor; and closing the switch or maintaining the switch in a closed position in accordance with determining that the net energy does not exceed the maximum energy capacity of the conductor.

The method of any preceding embodiment, further comprising obtaining a sensed current; and opening the switch in accordance with determining that the sensed current exceeds a current limit of the conductor.

The method of any preceding embodiment, wherein determining the net energy includes adding a sensed energy to a prior energy and subtracting the energy dissipation.

The method of any preceding embodiment, wherein determining the present energy includes sampling a current through the switch, squaring current samples from the sampling, and multiplying the squared current samples by a sampling time.

The method of any preceding embodiment, wherein determining the energy dissipation includes determining a difference between the present energy and a nominal energy of the conductor.

The electrical assembly of any preceding embodiment, wherein operating the switch according to the maximum energy capacity of the conductor and the net energy of the conductor includes adding a present energy to a prior energy and subtracting an energy dissipation.

The electrical assembly of any preceding embodiment, wherein operating the switch according to the maximum energy capacity of the conductor and the net energy of the conductor includes subtracting a present energy from a prior energy capacity and adding an energy dissipation.

The electrical assembly of any preceding embodiment, wherein determining the net energy includes storing squared current samples in a one-dimensional array.

The electrical assembly of any preceding embodiment, wherein determining the dissipation includes determining the dissipation is proportional to the oldest stored squared current sample.

The electrical assembly of any preceding embodiment, wherein determining the dissipation includes determining the dissipation is equal to the oldest stored squared current sample.

The electrical assembly of any preceding embodiment, wherein determining the dissipation includes determining the dissipation is equal to a product of the oldest stored squared current sample multiplied by a sample time.

A vehicle comprising the electrical assembly of any preceding embodiment.

An electronic controller configured to implement the method of any preceding embodiment.

A vehicle comprising the electronic controller of any preceding embodiment.

A non-transitory computer-readable storage medium having a computer program encoded thereon for implementing the method of any preceding embodiment.

A vehicle comprising the non-transitory computer-readable storage medium of any preceding embodiment.

In examples, a controller (e.g., the electronic controller 40) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An electrical assembly, comprising:
a conductor;
a switch electrically connected to the conductor; and
a control circuit connected to the switch, the control circuit including at least one of an electronic controller, a sensor, or a filter;
wherein the control circuit is configured to operate the switch according to a maximum energy capacity of the conductor and a net energy of the conductor.

2. The electrical assembly of claim 1, wherein operating the switch includes opening the switch in accordance with determining that the net energy exceeds the maximum energy capacity.

3. The electrical assembly of claim 2, wherein the control circuit is configured to determine an energy dissipation of the conductor and determine the net energy, at least in part, according to the energy dissipation.

4. The electrical assembly of claim 3, wherein the control circuit determines the energy dissipation, at least in part, according to a difference between a sensed energy and a nominal energy of the conductor.

5. The electrical assembly of claim 2, wherein the net energy of the conductor includes a sum of a present energy value and a prior energy value.

6. The electrical assembly of claim 5, wherein the control circuit includes the sensor;
the prior energy value includes a prior present energy value and a second prior energy value; and
the control circuit obtains the present energy value via the sensor.

7. The electrical assembly of claim 6, wherein the sensor is connected to sense a current at the switch; and
the present energy value corresponds to the current at the switch.

8. An electrical assembly, comprising:
a conductor;
a switch electrically connected to the conductor; and
a control circuit connected to the switch, the control circuit including at least one of a controller, a sensor, or a filter;
wherein the control circuit:
determines whether the conductor is in an equilibrium mode, a consumption mode, or a recovery mode;
determines an energy capacity value of the conductor according to the determined mode; and
controls the switch according to the energy capacity value.

9. The electrical assembly of claim 8, wherein controlling the switch according to the determined energy capacity value includes opening the switch if the energy capacity value is negative.

10. The electrical assembly of claim 8, wherein the control circuit determines that the conductor is in the equilibrium mode in accordance with determining that (i) a present current is less than or equal to a maximum current, and (ii) an expected capacity is within a threshold amount of a prior energy capacity value.

11. The electrical assembly of claim 10, wherein the expected capacity corresponds to a difference between a steady state current of the conductor squared and a measured current squared, multiplied by a steady state time.

12. The electrical assembly of claim 10, wherein the control circuit determines that the conductor is in the consumption mode in accordance with determining that the present current is greater than a nominal current of the conductor, and
the control circuit also determines that the conductor is in the consumption mode in accordance with determining that the expected capacity is less than the prior energy capacity value by more than the threshold amount.

13. The electrical assembly of claim 12, wherein the control circuit determines that the conductor is in the recovery mode in accordance with determining that (i) the conductor is not in the equilibrium mode or the consumption mode, and/or (ii) both of (a) the present current is less than or equal to the nominal current of the conductor, and (b) the expected capacity is greater than the prior energy capacity value by more than the threshold amount.

14. The electrical assembly of claim 13, wherein:
in accordance with determining that the conductor is in the equilibrium mode, the control circuit determines the energy capacity value is equal to the prior energy capacity value;
in accordance with determining that the conductor is in the consumption mode, the control circuit determines the energy capacity value is equal to a difference between the prior energy capacity value and a present energy of the conductor;
in accordance with determining that the conductor is in the recovery mode, the control circuit determines the energy capacity value equals a sum of the prior energy capacity value and an energy dissipation; and
operating the switch according to the energy capacity value includes opening the switch if the energy capacity value is negative.

15. The electrical assembly of claim 14, wherein the control circuit determines the energy capacity value for a plurality of sample periods.

16. A method of operating an electrical assembly, the method comprising:
determining a present energy of a conductor;
determining an energy dissipation of the conductor;
determining a net energy of the conductor, at least in part, according to the present energy and the energy dissipation;
opening a switch electrically connected with the conductor in accordance with determining that the net energy exceeds a maximum energy capacity of the conductor; and
closing the switch or maintaining the switch in a closed position in accordance with determining that the net energy does not exceed the maximum energy capacity of the conductor.

17. The method of claim 16, further comprising obtaining a sensed current; and
opening the switch in accordance with determining that the sensed current exceeds a current limit of the conductor.

18. The method of claim 17, wherein determining the net energy includes adding a sensed energy to a prior energy and subtracting the energy dissipation.

19. The method of claim 16, wherein determining the present energy includes sampling a current through the switch, squaring current samples from the sampling, and multiplying the squared current samples by a sampling time.

20. The method of claim 19, wherein determining the energy dissipation includes determining a difference between the present energy and a nominal energy of the conductor.
